(19) United States
(12) Patent Application Publication
(10) Pub. No.: US 2023/0195782 A1
(43) Pub. Date: Jun. 22, 2023

(54) Device and System to Identify a Water-Based Vessel using Acoustic Signatures

(71) Applicant: Anno.ai, Inc., Minnetonka, MN (US)

(72) Inventors: Steven Charles Witt, Minnetonka, MN (US); Matthew James Thomasson, Minnetonka, MN (US); Ashley Holt Antonides, Minnetonka, MN (US)

(21) Appl. No.: 18/087,500

(22) Filed: Dec. 22, 2022

Related U.S. Application Data
(60) Provisional application No. 63/292,736, filed on Dec. 22, 2021.

(51) Int. Cl. G06F 16/61

(52) U.S. Cl. CPC G06F 16/61

(57) ABSTRACT

A machine learning model can be developed and deployed to detect a water-based vessel, such as a maritime vessel, using acoustic data collected from sensors structured to detect sound traveling in water caused by operation of the water-based vessel. Information received from satellite tracking of vessels (either transponder based signals or imagery of a body of water having the vessels) can be used as a label to train the machine learning model to discern acoustic signatures related to the labelled vessel. The acoustic data is collected from a water-based platform, such as a buoy, which includes one or more acoustic sensors. Other sensor types can also be used to train the data-based model on other aspects of the vessel, such as radar, infrared, electro-optical, and/or lidar. The buoys can be mounted to the seafloor or permitted to be free floating of the type that can either maneuver itself or be required to be repositioned from time to time. More than one buoy can be used to collect data.

### TECHNICAL FIELD

The present disclosure generally relates to water-based vessel remote sensing, and more particularly, but not exclusively, to maritime vessel remote sensing using a machine learning trained data-based model.

### BACKGROUND

Providing identification of maritime vessels in the absence of satellite tracking data remains an area of interest. Some existing systems have various shortcomings relative to certain applications. Accordingly, there remains a need for further contributions in this area of technology.

### SUMMARY

One embodiment of the present disclosure is a unique machine-learning model structured to detect water-based vessel traffic. Other embodiments include apparatuses, systems, devices, hardware, methods, and combinations for identifying maritime vessel traffic from acoustic signatures. Further embodiments, forms, features, aspects, benefits, and advantages of the present application shall become apparent from the description and figures provided herewith.

### BRIEF DESCRIPTION OF THE FIGURES

FIG. 1A depicts a schematic illustrating an embodiment of a machine learning model trained using satellite data and capable of detecting a water-based vessel.

FIG. 1B depicts a schematic illustrating an embodiment of a machine learning model trained using satellite data and capable of detecting a water-based vessel.

FIG. 2A depicts an embodiment of a training pipeline in the development of a data-based model.

FIG. 2B depicts another embodiment of a training pipeline in the development of a data-based model.

FIG. 3 depicts an embodiment of operation of a data-based model.

FIG. 4 depicts an embodiment of a computing device used with one or both of FIGS. 2 and 3.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

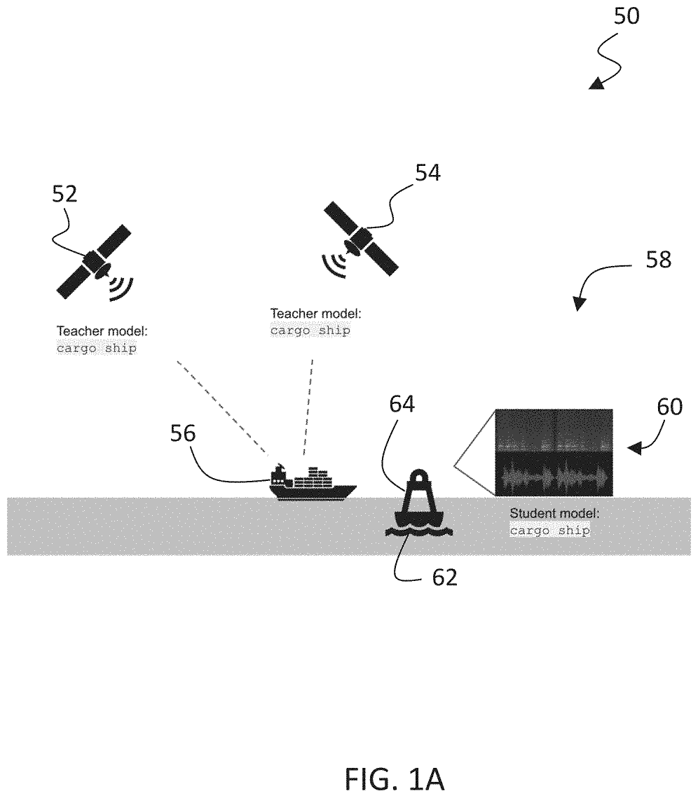

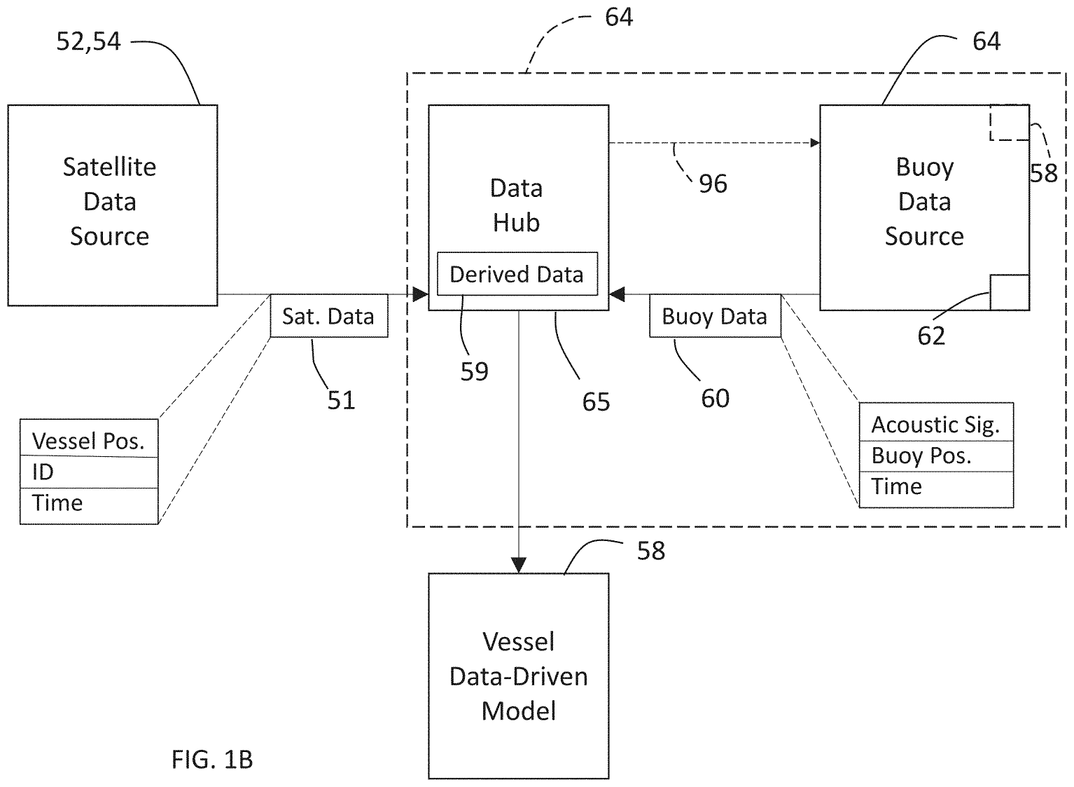

Disclosed herein is a system and method to utilize satellite data of maritime vessels traveling a body of water to develop a data-based model to recognize the vessel based on acoustic data collected from one or more acoustic sensors, and thereafter the deployment of such a model in an operational setting. FIGS. 1A and 1B illustrates a system 50 in which information (sometimes referred to herein as “satellite data” 51) available from satellites 52 and 54 related to the type or identification of a vessel 56 are used as a “teacher” to aid the “student” data-based model 58 in identifying the vessel 56 using acoustic data 60 recorded using an acoustic sensor 62 coupled with a buoy 64. It will be understood that the teacher-student relationship described above is sometimes referred to as supervised learning. As used herein, the “student” data-based model 58 may sometimes be referred to as a “vessel data-driven model” 58 or simply “data-driven model” 58, and the acoustic data 60 may sometimes be referred to as “marine acoustic data” 60 or “buoy data” 60. The satellite data 51 and buoy data 60 can be provided to a data hub 65 for subsequent processing and development of the vessel data driven model 58. No limitation in terms of origin or type of data is intended with respect to the model 58 or the data 60 unless expressly indicated to the contrary. Thus, like reference numerals apply to like elements, and any variations in one form of the same reference numeral are applicable to all.

The acoustic sensors 62 of FIG. 1 can be coupled with water-based platforms 64, often but not always in the form of a buoy, which are capable of collecting vibrations carried in the water and associated with underwater sound. Reference may be made herein to “buoy 64” for ease of reference with respect to a non-limiting example of water-based platform 64, but it will be appreciated that no limitation is intended regarding such use. As such, any description of, or use of the term “buoy” or “buoy 64” will be understood to apply as well to any given embodiment of a water-based platform, unless expressly indicated to the contrary. Vibrations that are produced and carried through the water are often as a result of operation of the vessel 56 in the water. Vessel operations can include sailing while under power, maneuvering while in/near port, and idling of engines, among any variety of other vessel operations which produce sound vibrations in the water. Vibrations produced as a result of vessel operations have any number of discrete sources, such as but not limited to, the engine, drive train, propeller, propeller-water interactions, maneuvering thrusters, water passage along the hull, bow waves, wake from the stem, etc. It will be appreciated that vibration data is typically defined by a high frequency waveform best sampled with high-rate sensors to capture sufficient data signatures within the underwater sound. In some forms the frequencies are between 10 Hz and 1 MHz, but other ranges are also contemplated herein. The acoustic sensors 62 are contemplated to be structured to capture all relevant vibrations of any acoustic frequency, whether audible by a human ear or not.

During the training process acoustic data 60 captured by the sensors 62 can be paired, correlated, or otherwise associated with an identification of a vessel 56 that contributed to the acoustic data 60. In additional embodiments, other data can also be included in the buoy data along with the acoustic signature, including, but not limited to, the position of the buoy and the current time of data collection. Identification of the vessel 56 can be made available through satellite data 51 (designated as “ID” in FIG. 1B). The training process used to create the data-based model can rely upon any variety of artificial intelligence/machine learning techniques, including among others decision tree, random forest, support vector machines, perceptrons, naïve Bayes, logistic regression, linear regression, k-nearest neighbor, artificial neural networks/deep learning, bagging, and AdaBoost, to set forth just a few examples. After training the data-based model can thereafter be deployed to identify the vessel based solely upon sound captured by the sensors in the absence of satellite data identification.

Various forms of satellite based data useful in identifying the location of a vessel are typically available through a variety of sources, and include diverse data sets, such as those available through transponder tracking and other surveillance products including imagery. Automatic Identification System (AIS) is a tracking system that uses transmitters carried by vessels 56 to emit a signal that can be received by terrestrial and/or space based assets (e.g. 52 and/or 54). The signal that conveys the satellite data 51 can include information, such as a unique identification code (“ID”) for the vessel, position (“Vessel Pos.”), time, course, and speed. In some forms a subset of the information is provided via the satellite, with the remainder capable of being calculated. Information of the vessel made possible by transponder tracking can be made available to end users for tracking and/or status purposes. Imagery based data can also be included in the satellite data 51, either additional to or alternative of the data just discussed, and made available to end users for tracking and/or status purposes. Imagery based data from the satellite can include photographs in the visible light spectrum, images in the infrared spectrum, data provided from synthetic aperture radar (SAR), etc. Data 51 provided from satellite sources, whether in the form of transponder signals, such as through AIS, or imagery information, such as through SAR, can be a useful tool through which to track and monitor maritime traffic.

In some operational settings transponder related satellite data may be unavailable and/or unreliable to track and monitor maritime vessels 56. Countries, such as China, have been known to order sailing vessels to disable, turn off, or otherwise render inert equipment on board vessels that transmit data related to position of the vessel 56 when sailing in certain waters. Such requirements may be related to privacy and/or security related concerns. In still other situations, overt acts to ‘spoof’ the identity of a vessel 56 by deliberately transmitting counterfeit identification are undertaken for personal, commercial, or national gain. Examples of purposely rendering inoperative or ‘spoofing’ of transponder signals relate to illicit activities, such as during smuggling operations, illegal fishing, and geopolitical gamesmanship intended to imply a vessel flagged under a particular country deliberately breached a boundary line of another country. Whether legally required or otherwise desired for illicit purposes, the absence of satellite based transponder identifications impedes monitoring and surveillance activities associated with the position of vessels while it is traveling a body of water.

In situations in which transponders are rendered inoperative and/or intentionally corrupted (e.g. spoofing), satellite imagery can be used to augment tracking of the vessels 56. Machine learning techniques have previously been developed to associate an image (photograph, SAR, etc.) of a vessel with a known source of data for identification including that of a transponder signal, such as from AIS. Data-based models derived from pairing AIS signals with that of satellite images can be used to generate vessel position based solely on the data-based model in the absence of reliable AIS signals. Satellite produced images can therefore also be used to train the data-based model to identify position akin to AIS transponder signals. However, satellites may not provide persistent coverage: Satellite assets can provide a large range of coverage, but depending on their orbits and revisit rate may not be able to provide persistent coverage, especially for moving objects (e.g., boats or icebergs). Embodiments herein also support persistent coverage and measurements of target maritime objects.

Whether the satellite data 51 is provided from AIS related sources and/or from satellite imagery, such data 51 can be transmitted to the data hub 65 using any variety of connections including wireless and wired.

Whether using AIS related sources or satellite imagery, or both, knowledge of the vessel's identify and/or location through AIS or imagery permits automatic labeling of an underwater sound event recorded by the acoustic sensors 62. The sensor 62 positioned on the water-based platform 64 can be configured to record underwater sound data using a variety of approaches, from continuous monitoring, on-demand monitoring, recurring monitoring, and random monitoring. In addition, the sensor 62 (and associated processing hardware) can be configured to report data in real-time during a collection, and alternatively can be configured to cache the data for later transmission/computation/etc. However collected and whenever transmitted, the underwater sound event can be labelled having at least some sound content related to the vessel identified using AIS or imagery data.

Given the propensity for sound to travel sometimes large distances but nevertheless eventually suffering a computationally relevant decrease in sound level, it can be useful during the development of the data-based model to label a sound event as associated with a vessel when the vessel 56 is within a given range. The given range associated with a labeling event and subsequent processing of data can take many different forms. In some embodiments the range can be a predefined geometric distance which may be related to the time of day, temperature of water, etc. Such geometric distances can be calculated in advance and may depend on any number of factors, such as quality of sensor, environmental noise, etc. In other alternative and/or additional embodiments, the given range can be dependent upon the body of water in which the vessel 56 is operating, and/or can be dependent upon the amount of maritime traffic in the vicinity of the vessel. Signal to Noise Ratio (SNR) can also be used to determine whether a vessel 56 is within range.

Since there are any number of vessels sailing large bodies of water at any given time, and given the propensity for sound to travel long distances in water, it is possible for the underwater sound event to be labelled with many different vessels 56. For that reason, sound data can be curated and events labelled when only one vessel 56 is within defined range of the sensor during the training process of the data-based model. In other instances, any given sound event can be labelled with the number of vessels 56 in range of the sensor during the captured sound event.

Although the training data can be provided with a label of vessel identification above, in alternative and/or additional embodiments, label(s) of vessel identification(s) can be provided along with any other relevant information useful to aid in identifying a vessel 56 through acoustic signature captured with the sensor 62. Such other relevant information can include any of one or more of distance of the vessel 56 from the buoy, bearing of the vessel 56 from the buoy, orientation of the vessel 56 relative to the buoy, etc. (e.g., derived data 59 in FIG. 1B). Such data can be derived from the satellite data 51 and/or buoy data 60. Further, such data can be provided for training purposes to aid in creation of a data-based model capable of outputting relevant details of the vessel 56 (e.g. identification of vessel, vessel type, etc.) as well as its relative bearing and/or position, and in some additional and/or alternative forms can be used to further distinguishing vessels in a multi-vessel environment. In some forms the labelled data can include a single discrete datapoint for which training can commence, but in other forms the training data can include multiple discrete points (multiple points along the route of travel of the vessel 56 while within range of the sensor 62). In still other forms the training data can include time histories along a segment of travel of the vessel. As will be appreciated, the vessel data-driven model 58 can be trained and generated at the data hub 65, but it is contemplated that other computing devices can also be used to train the vessel data-driven model 58.

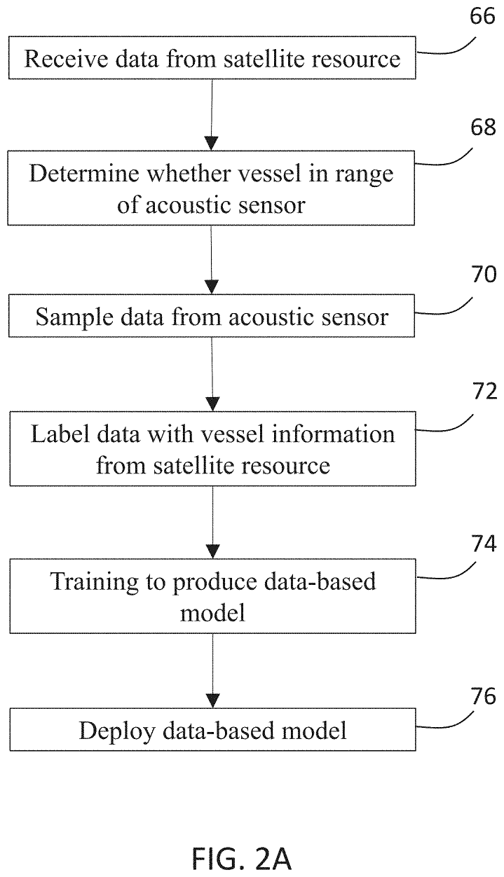

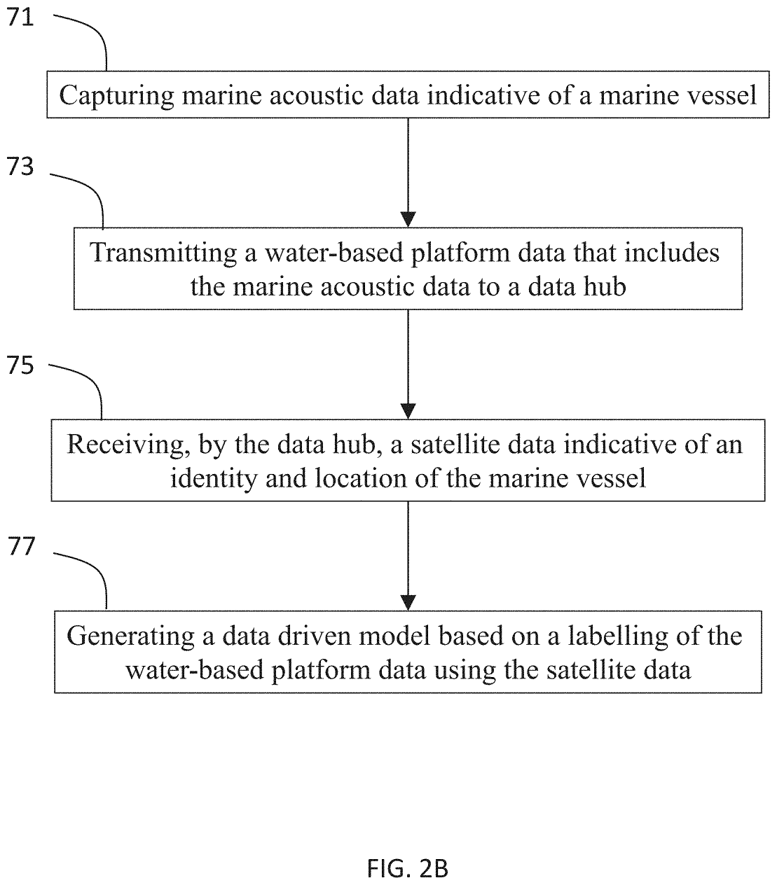

Turning to FIG. 2A, a development process is disclosed which illustrates a pipeline of activities associated with sampling and labeling of data, training the AI/machine learning system, and deploying a trained model to an operational setting. Step 66 involves receiving data from a data source (e.g. AIS, satellite imagery) indicative of locations of vessels sailing any given body of water. The data received at 66 can take a variety of forms including lat/long coordinates of current position, time of data capture, lat/long of sailing route, etc. (included in satellite data 51 above). After receipt of data (AIS, imagery, etc.) in step 66, and given knowledge of the location of water-based asset(s) 64 (e.g., via buoy data 60), a determination can be made in 68 whether the vessel 56 is within range of the water-based asset 64 using, for example, any of the techniques described herein. If a vessel 56 is within range, data taken from the acoustic sensor at step 70 (or a derived data product) can be labelled at step 72 for purposes of training the data-driven model at step 74. Derived data products (e.g., derived data 59) can include any number of waveform characteristics including: level and gain, frequency domain analysis (e.g. through use of wavelet transforms), etc. Further, the data taken from the acoustic sensor at step 70 can include direct conversion to electronic data from the acoustic sensor without data processing, filtering of data captured from the microphone, signal processing of the data captured from the microphone, data wrangling the data captured from the microphone, etc. (all of which are also included in derived data 59). In some embodiments, however, some or all of the derived data can take place at either or both of the satellite data source 52,54 or the buoy data source 64. In short, any number of data processes are contemplated with respect to producing sound vibration data.

FIG. 2B depicts an alternative and/or additional development process also illustrating a pipeline of activities associated with sampling and labeling of data, training the AI/machine learning system, and deploying a trained model to an operational setting. Step 71 includes capturing marine acoustic data using the sensor 62, where the data is indicative of a marine vessel 56. The acoustic data can be included in a marine acoustic data. At step 73, the method includes transmitting the water-based platform data that includes the marine acoustic data to a data hub, such as data hub 65. Step 75 includes receiving, by the data hub, a satellite data 51 indicative of an identity and location of the marine vessel 56. Once received by the data hub 65, the method at step 77 further includes generating a data driven model 58 based on a labeling of the water-based platform data 60 using the satellite data 51.

Upon completion the data-based model can be deployed for operational use to augment and/or replace satellite data.

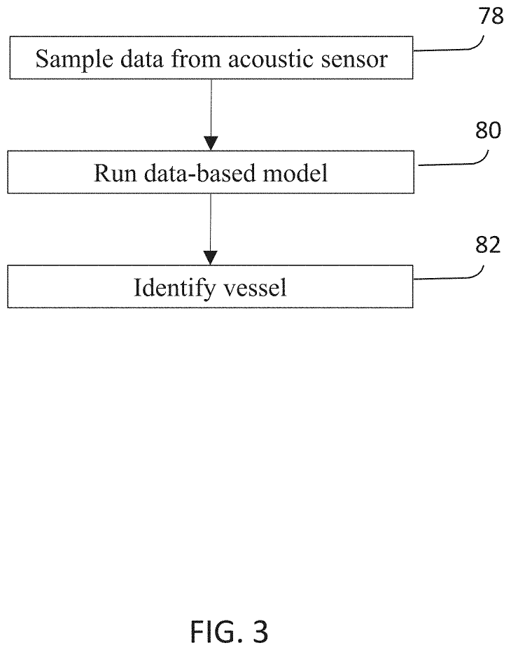

FIG. 3 describes a process by which a trained model is deployed and used with acoustic data 60 from the acoustic sensor 62. During deployment data sampled from the acoustic sensor 62 (or a derived data product mentioned above) can be provided to the data-based model at step 80 which is capable of producing an identification of the vessel, or the vessel identification, or any number of other attributes which will be appreciated from the description herein (e.g., distance to vessel, bearing between vessel and buoy, relative orientation of the vessel, etc.). The output of the machine learning data-based model at step 82 can take a variety of forms. For example, the output can indicate that the machine learning confirms the identity and/or type of vessel as being reported in the AIS system. Such a system can act as sentries that report, say, T or F depending on whether the vessel reported on AIS matches the vessel output from the trained model. In other forms the output of the machine learning can be an identifier of the vessel for later confirmation in a downstream process. In such a form the machine learning merely reports the outcome from the model. Confidence intervals and/or probability of identification can be provided as output from the trained model. Further to the above, the output can be provided in the form of an alarm to an operator, a printed report of vessels identified by the data-based model, or a formatted digital response in return to a query issued by an end user. In short, the output can take any variety of forms including audible, hardcopy, and digital, all in the service of providing an identification of a vessel either in the absence of satellite data or in augmentation of it. The deployed data-based model can be hosted in a number of locations by a computing device which are configured to receive all or part of the buoy data 60, and can include any of the variations described herein of data useful to train the data-based model 58.

As discussed above, the output of the machine learning can be broadcast to a customer when AIS data is not available. Such broadcast can include the type of vessel, ID of vessel, speed of vessel, heading of vessel, bearing to vessel, distance to vessel. In some instances bearing information from each buoy can be used to provide range from buoys and ultimately location of vessel. In case of GPS outage, maybe just report bearing from buoy and possibly relative ranging from buoy if multiple buoys are reporting information.

Referring now to FIGS. 1-3, further description is provided below of various further alternative and/or additional embodiments to the discussion above. The water-based platform 64 on which the acoustic sensor 62 is attached can be a buoy as described above, but can also take a variety of other water-based platform types. For example, the water-based platform can be anchored to the seabed (or the equivalent bottom of other bodies of water, such as a riverbed, lakebed, etc.). The water-based platform 64 can be free floating, or can be free floating with its own propulsion system (electric powered, gasoline powered). In some forms the water-based platform 64 can take the form of a water-based autonomous vehicle. In forms capable of providing maneuvering, the water-based platform 64 can be configured to maintain a position through continuous means, or be commanded to maintain position at various points throughout a duty cycle. In some embodiments, the water-based platform 64 can be submersible or floating.

It will be appreciated in some forms that multiple water-based platforms 64 can be used, each with their own acoustic sensor 62. These platforms 64 can be deployed in the same body of water and capable of capturing sound emanating from a vessel 56. These platforms 64 can be networked together to collaborate, or can be individuated where data collected can be collated at another location (e.g. terrestrial control station to set forth just one non-limiting example) for model training.

The acoustic sensors 62 coupled to the water-based platforms 64 are contemplated for operational deployment to a large body of water, such as but not limited to an oceanic body of water, smaller seas associated with nearby landmasses, gulfs, and harbors. That said, the acoustic sensors are also contemplated to being deployed in any variety of other types of bodies of water, including rivers, lakes, ponds, and streams. Accordingly, it will be appreciated that the acoustic sensors are intended to cover a wide range of bodies of water including those of the salt water, fresh water, and brackish water types.

The acoustic sensors 62 are structured to measure a variety of vibrational frequencies carried in the body of water, including those frequencies that are audible to a person while otherwise submerged in the water. Other ranges are also contemplated including but not limited to those in the infra-sound range. Hydrophones are one example of an acoustic sensor 62 used to capture the vibrational frequencies. One or more acoustic sensors 62 can be deployed on any given water-based platform 64. Any given arrangement of acoustic sensors 62 are contemplated in those embodiments having multiple sensors 62 on a given platform 64. The sensors 62 can be arrayed in a directional pattern in one or more directions in some forms, while other forms include an array of sensors 62 arranged circumferentially to sweep the periphery of the platform 64. Not all sensors 62 need to be the same.

As will be appreciated in the description above, the platform 64 can include a transmitter used to broadcast data, where the sensor 62 and transmitter together are controlled by a computing device onboard the platform 64. Transmitters can take the form of an RF transmitter, laser transmitter, and acoustic speakers to set forth just a few nonlimiting examples. In the case of a platform 64 configured to offload data using a connected wireline it will be appreciated that the transmitter may come in the form of a network interface card, signal generator, etc.

The computing device used to collect data from the sensor 62 and control the transmitter can take a variety of forms. One or more computing devices can be used aboard the platform 64. In some embodiments, the computing device at the buoy can be configured as an edge computing device in which substantial processing is contemplated, up to and including local training o the machine learning model.

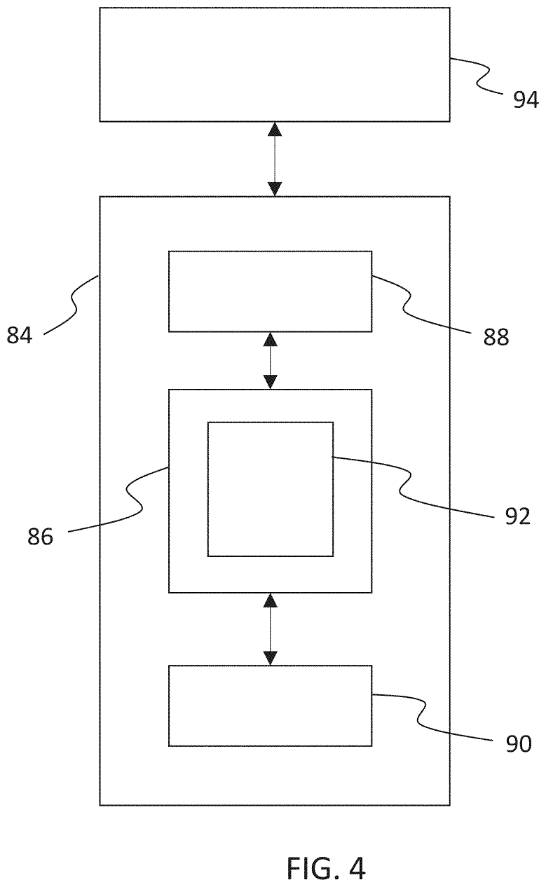

FIG. 4 depicts one embodiment of the computing device useful to capture data from sensor 62 and control the transmitter. The computing device, or computer, 84 can include a processing device 86, an input/output device 88, memory 90, and operating logic 92. Furthermore, computing device 84 can be configured to communicate with one or more external devices 62. It will be appreciated that the computing device 84 can be used to collect, calculate, derive, generate models, display data, etc. for any of the systems included herein, such as but not limited to the buoy 64, data hub 65, and satellite 52,54, among potential others.

The input/output device 88 may be any type of device that allows the computing device 84 to communicate with the external device 94. For example, the input/output device may be a network adapter, network card, or a port (e.g., a USB port, serial port, parallel port, VGA, DVI, HDMI, FireWire, CAT 5, or any other type of port). The input/output device 88 may be comprised of hardware, software, and/or firmware. It is contemplated that the input/output device 88 includes more than one of these adapters, cards, or ports.

The external device 94 may be any type of device that allows data to be inputted or outputted from the computing device 84. To set forth just a few non-limiting examples, the external device 94 may be another computing device, a printer, a display, an alarm, an illuminated indicator, a keyboard, a mouse, mouse button, or a touch screen display. In some forms there may be more than one external device in communication with the computing device 84, such as for example another computing device structured to receive the acoustic data. Furthermore, it is contemplated that the external device 94 may be integrated into the computing device 84. In such forms the computing device 84 can include different configurations of computers 84 used within it, including one or more computers 84 that communicate with one or more external devices 62, while one or more other computers 84 are integrated with the external device 94.

Processing device 86 can be of a programmable type, a dedicated, hardwired state machine, or a combination of these; and can further include multiple processors, Arithmetic-Logic Units (ALUs), Central Processing Units (CPUs), or the like. For forms of processing device 86 with multiple processing units, distributed, pipelined, and/or parallel processing can be utilized as appropriate. Processing device 86 may be dedicated to performance of just the operations described herein or may be utilized in one or more additional applications. In the depicted form, processing device 86 is of a programmable variety that executes algorithms and processes data in accordance with operating logic 92 as defined by programming instructions (such as software or firmware) stored in memory 90. Alternatively or additionally, operating logic 92 for processing device 86 is at least partially defined by hardwired logic or other hardware. Processing device 86 can be comprised of one or more components of any type suitable to process the signals received from input/output device 88 or elsewhere, and provide desired output signals. Such components may include digital circuitry, analog circuitry, or a combination of both.

Memory 90 may be of one or more types, such as a solid-state variety, electromagnetic variety, optical variety, or a combination of these forms. Furthermore, memory 90 can be volatile, nonvolatile, or a mixture of these types, and some or all of memory 90 can be of a portable variety, such as a disk, tape, memory stick, cartridge, or the like. In addition, memory 90 can store data that is manipulated by the operating logic 92 of processing device 86, such as data representative of signals received from and/or sent to input/output device 88 in addition to or in lieu of storing programming instructions defining operating logic 92, just to name one example.

Returning now to FIGS. 1A and 1B, sound data collected from the sensors 62 (for purposes of model training and/or trained model operation) can be transmitted to another location for processing (e.g., the, or in some forms can be processed local to the water-based platform 64. For example, spectral analysis can be performed at the platform 64 and transmitted to a separate location for subsequent analysis. It will therefore be appreciated that the sensor 62 can be in communicative relationship with another computing device using any variety of devices including wireline and wireless. Such communicative relationship can include long or short range technologies (infrared, Bluetooth, wireless, esp-now, LoRa, 4G LTE, etc.) using any variety of communication protocols (Ethernet, LoRaWAN, point-to-point, etc.) and related bandwidths.

The platform 64 can be configured to offload data (or processed data) in any given interval as discussed above. In addition, the platform 64 can be in communication with another platform used to intermittently collect signals for a subsequent offloading event, for example from a passing vessel, airborne aircraft, and/or satellite. In some forms the platforms 64 can be networked together in which data can be aggregated and reported as a class of platforms. Receivers can be any suitable asset including aircraft, satellite, and in some forms a receiver mounted to the sea floor.

Also of note in FIG. 1B, in some applications the data hub 65 may reside at the buoy 64 as shown in the dotted line which encompasses the buoy 64 and the data hub 65. In such an embodiment, when the vessel data driven model 58 is deployed it may reside in the buoy 64 as opposed to residing elsewhere in the embodiment in which the buoy 64 is separate from the data hub 65. The dotted lines, therefore, used in FIG. 1B depict an alternative embodiment in which the data hub 65 and the vessel data driven model 58 reside in the buoy 64. The solid lines depict an embodiment in which the data hub 65 may be a remote data center which receives buoy data 60 and satellite data 51.

Also of note in FIG. 1B, in some embodiments the data hub 65 may be capable of transmitting to the buoy 64 as shown by reference number 96. In such an embodiment the data hub 96 may communicate with the buoy 64 to request and/or coordinate the offloading of data from the buoy 64. In another embodiment in which the data hub 65 is part of the buoy 64, the communication of data via 96 may be through an internal data bus or sharing of memory, where the data hub is a functional component that designates a portion of the system responsible for receiving the satellite data 51.

One aspect of the present application includes a method comprising: capturing sound vibrations traveling in water with an acoustic sensor, the sound vibrations produced from a water-based vessel operating in a body of water; producing sound vibration data derived from the capturing of sound vibrations with the acoustic-sensor; providing the sound vibration data to a machine learning data-based model, the data-based model structured to convert the sound vibration data to a prediction of the water-based vessel; and generating a prediction of the water-based vessel.

One feature of the present application includes wherein the water-based vessel is a buoy.

Another feature of the present application includes wherein the water-based vessel is one of a vessel tethered to a floor of the water and a free-floating vessel.

Yet another feature of the present application includes wherein the acoustic sensor is a hydrophone.

Still another feature of the present application includes wherein the providing includes transmitting the sound vibration data from the vessel to a remote station having the machine learning data-based model.

Another aspect of the present application includes a method comprising: capturing data with a maritime-based sensor of a water-based vessel operating in a body of water; producing sensor data derived from the capturing data; providing the sensor data to a machine learning data-based model, the data-based model structured to convert sensor data to a prediction of the water-based vessel; and generating a prediction of the water-based vessel.

A feature of the present application includes wherein the maritime-based sensor is one of an acoustic sensor, radar, infrared, electro-optical, and lidar.

Although the description herein is related to identifying a sound using machine learning techniques applied to an underwater acoustic signature, other sensors could also be deployed as either a replacement or to supplement the water-based acoustic sensors. For example, sensors such as radar, infrared, electro-optical, and/or lidar can also be used wherein labelled data is used to inform the machine learning that data derived from these other types of sensors is related to a particular vessel and/or vessel type.

It will also be appreciated that although the data-based model is trained using acoustic data from either AIS or satellite imagery, in some forms the data-based model can be trained with AIS data and subsequent use of the data-based model used to train another, second data-based model. Such subsequent use can include using the first data-based model to output vessel identification that can be used to label satellite imagery for training the second data-based model. For example, use of an acoustic signature permits identification of a specific vessel by type and/or name from a buoy or underwater acoustic array, where that identification could be used to train a satellite-based sensor (e.g. a satellite sensor that produces imagery products). Such a secondary training could be beneficial during a cyberattack or supply chain compromise that would enable a crippling attack on global acoustic buoys and oceanic arrays, thereby forcing reliance upon satellite networks as primary collection fallback.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A system comprising:
a water-based platform having an acoustic sensor and a transmitter, the acoustic sensor structured to capture marine acoustic data indicative of a marine vessel, the transmitter structured to transmit a water-based platform data that includes the marine acoustic data;
a data hub configured to:
receive a satellite data indicative of an identity and location of the marine vessel;
receive the water-based platform data; and
generate a data driven model based on a labeling of the water-based platform data using the satellite data.

2. The system of claim 1, wherein the water-based platform includes a plurality of water-based platforms distributed in a maritime operating area, and wherein the data hub is configured to receive water-based platform data from each of the plurality of water-based platforms.

3. The system of claim 2, wherein the water-based platform data from each of the plurality of water-based platforms also includes a location data of each water-based platform, the location data of each water-based platform paired with the marine acoustic data of each water-based platform.

4. The system of claim 2, wherein the water-based platform data from each of the plurality of water-based platforms also includes a time data, the time data of each water-based platform paired with the marine acoustic data of each water-based platform.

5. The system of claim 4, wherein the satellite data is indicative of an identity and location of a plurality of marine vessels, and wherein the data hub is configured to receive the satellite data and label the acoustic data of the water-based platform data with the plurality of marine vessels.

6. The system of claim 4, wherein the satellite data is indicative of an image including the location of a plurality of marine vessels, wherein the data hub is configured to receive the satellite data and label acoustic data of each of the marine vessels of the plurality of marine vessels using the image.

7. The system of claim 4, wherein the satellite data is used to curate the water-based platform data by labeling the water-based platform data when the marine vessel is within a defined range of the water-based platform.

8. The system of claim 4, wherein the data driven model is also generated based on labeling the water-based platform data using derived data from the satellite data.

9. The system of claim 8, wherein the data derived from the satellite data includes at least one of (1) distance between the marine vessel and the water-based platform; (2) bearing of the marine vessel from the water-based platform; and (3) orientation of the marine vessel relative to the water-based platform.

10. A method comprising:
capturing marine acoustic data indicative of a marine vessel;
transmitting a water-based platform data that includes the marine acoustic data to a data hub;
receiving, by the data hub, a satellite data indicative of an identity and location of the marine vessel;
generating a data driven model based on a labeling of the water-based platform data using the satellite data.

11. The method of claim 10, wherein the capturing includes capturing marine acoustic data of a plurality of water-based platforms in a maritime operating area, and transmitting water based platform data for each of the plurality of water-based platforms to the data hub.

12. The method of claim 11, wherein the water-based platform data from each of the plurality of water-based platforms also includes a location data of each water-based platform, the location data of each water-based platform paired with the marine acoustic data of each water-based platform.

13. The method of claim 11, wherein the water-based platform data from each of the plurality of water-based platforms also includes a time data, the time data of each water-based platform paired with the marine acoustic data of each water-based platform.

14. The method of claim 13, wherein the satellite data is indicative of an identity and location of a plurality of marine vessels, and which further includes labeling the acoustic data of the water-based platform data with at least the identity of the plurality of marine vessels.

15. The method of claim 13, wherein the satellite data is indicative of an image including the location of a plurality of marine vessels, and which further includes labeling acoustic data of each of the marine vessels of the plurality of marine vessels using the image.

16. The method of claim 13, which further includes curating the water-based platform data by labeling the water-based platform data when the marine vessel is within a defined range of the water-based platform.

17. The method of claim 13, which further includes generating the data driven model based on labeling the water-based platform data using data derived from the satellite data.

18. The method of claim 17, wherein the data derived from the satellite data includes at least one of (1) distance between the marine vessel and the water-based platform; (2) bearing of the marine vessel from the water-based platform; and (3) orientation of the marine vessel relative to the water-based platform.
